(19) United States
(12) Patent Application Publication
(10) Pub. No.: US 2006/0032408 A1
(43) Pub. Date: Feb. 16, 2006

(54) Method of making pozzolands and cementitious materials from coal combustion by-products

(76) Inventor: William M. Strabala, Arvada, CO (US)

Correspondence Address: SHERIDAN ROSS PC, 1560 BROADWAY, SUITE 1200, DENVER, CO, 80202, US

(21) Appl. No.: 11/203,044

(22) Filed: Aug. 12, 2005

Related U.S. Application Data
(60) Provisional application No. 60/601,588, filed on Aug. 12, 2004.

(51) Int. Cl. C04B 18/06

(52) U.S. Cl. 106/705

(57) ABSTRACT

Ash produced by many coal-fired utilities has little or no commercial value as a cement additive or as a component in building materials because of its chemical or mineralogical composition. This condition is especially common with ash materials produced by Fluidized Bed Combustion boilers (FBC) or Circulating Fluidized Bed Combustion boilers (CFBC) fired with bituminous coal or waste coals (gob) reclaimed from inactive coal mine sites. The present invention describes a novel process that converts otherwise low-value materials such as bottom and fly ashes produced by a FBC or CFBC boilers, for example, into materials that have desirable physical, chemical and mineralogical compositions that can be used as a valuable cement additive or component in building materials. The novel process closely integrates the boiler (steam generator) that produces the ash with a new high-temperature process, such as a kiln. The ash is mixed with limestone or other bulk materials to provide a feed for the kiln of the desired chemical composition. The mixture is treated at elevated temperatures in the kiln to produce a product, that in combination with further processing, exhibits desirable pozzolanic properties. Integrating boiler and kiln operations provides economic and environmental benefits. Waste heat produced by the kiln that would otherwise be released into the atmosphere is made available to the steam or turbine cycle, thus improving the overall boiler heat rate. Effluents and gases produced by the kiln may be efficiently treated by the boiler environmental control systems or independent environmental control systems. Novel production methods and feed materials will be claimed.

### RELATED APPLICATION

This application claims priority from U.S. Provisional Patent Application No. 60/601,588 filed on Aug. 12, 2004. The entire disclosure of the provisional application is considered to be part of the disclosure of the accompanying application and is hereby incorporated by reference.

### FIELD OF THE INVENTION

The present invention is directed to a method and product useful in building materials and, in particular, relates to the production of pozzolanic materials for use as a mortar-type compound.

### BACKGROUND OF THE INVENTION

This invention relates to the production of pozzolanic materials that can be added to Portland cement to reduce the cost of making concrete, and as an economic cementitious component in manufacturing certain types of building materials.

Various strategies have been developed by the coal combustion by-product industry to use certain bottom and fly ashes as pozzolans, finely-divided materials that react with calcium hydroxide and alkalis to form compounds possessing cementitious properties. The glassy spherical particulates present in certain ashes are the active pozzolanic component. The American Society for Testing and Materials (ASTM) defines Class F fly ash as an ash that readily reacts with free lime present when Portland cement hydrates to form cementitious compounds. Class C fly ash also may exhibit hydraulic (cementitious) properties when mixed with water.

Not all ashes produced by coal combustion have desirable pozzolanic properties and they must be disposed in a landfill at great cost. The operating conditions of FBC and CFBC boilers are not suitable for producing pozzolanic ashes from some coals, and especially from waste coal that is typically found in Eastern United States coal producing areas. The present invention transforms these non-pozzolanic ashes into valuable materials by adding limestone or other bulk materials of a specified composition to the ash, and then treating the mixture at elevated temperatures to form products containing mineral species that provide the desired properties when use as a dry cement additive or with water to form cementitious compounds.

The invention describes methods of processing mixtures of ashes produced by coal combustion and other bulk materials. The process becomes economically attractive when the methods described in the patent are used to integrate the system that generates the ash with the high-temperature kiln process. Processes that generate ash from coal combustion include FBC, and CFBC boilers. FBC and CFBC boilers in particular, are chosen to generate steam for electrical power production because of favorable environmental and economic considerations.

Integration provides economic benefits by dispatching heat generated by the kiln that would otherwise be wasted to the atmosphere with the steam and turbine cycles. The net result is reduced fuel consumption to generate a given quantity of electrical energy. Integration also provides environmental benefits by possibly treating the effluents and gases produced by the kiln with environmental control equipment located with the boiler. The net result is substantially less sulfur dioxide and nitrogen oxide emissions than experienced by many stand-alone kilns. The third, and most significant benefit, is reducing the amount of ash materials that must otherwise require landfill disposal. In areas that have substantial waste coal reserves such as in Appalachia, integrating a boiler fired by coal waste with the process reduces environmental stress caused by acid drainage emanating from the waste.

### SUMMARY OF THE INVENTION

The present invention describes, in one embodiment, the manufacture of a material that can be used as a cement additive or component in the building material by combining ashes produced by coal combustion with limestone or other bulk materials, and treating the mixture in a kiln Ash materials, including bottom ash and fly ash produced by FBC and CFBC boilers, is mixed in a specified proportion, with limestone and possibly other bulk materials to form a mixture of a specified chemical composition. The proportioning of the ash and other materials can be controlled by weigh feeders or other gravimetric feeding devices. The analysis of the mixture, provided by traditional chemical assays, x-ray diffraction (XRD), or prompt gamma neutron activation (PGNA) methods, for example, is used to compute the desired proportions.

The mixture of ash, limestone, and other bulk material is ground to a fine size and fed at a controlled rate to the kiln. Feed material enters the cold end of the kiln, and flows counter-current to the heat introduced at the hot end of the kiln.

The temperature profile in the kiln is carefully controlled to produce the desired physical and chemical reactions including drying, calcining, and burning (clinkering). The desired temperature profile is dependent on the composition of the feed and product specifications. In one embodiment, the temperature profile is adjusted to retain a significant percentage of sulfur compounds in the final product to provide a cementitious material that exhibits rapid curing characteristics. In another embodiment, the temperature profile is adjusted to produce compounds, when hydrated, form strong and durable materials.

The kiln product is cooled and ground to fine size for use. The finished product can be shipped in bulk to customers, used on site to produce building products, or bagged.

In one example of the invention, a CFBC boiler fired with waste coal will produce steam to produce electrical power, bottom ash, and fly ash. A kiln, located adjacent to the boiler, receives a portion of the ash produced. The ash is mixed with limestone, in a variable ratio, typically one part ash to one part limestone. The mixture is ground to a fine size, typically less than 74 microns, in a ball mill. The powder mixture is fed to the kiln for drying, calcining and burning. Coal provides the thermal energy necessary for these physical and chemical reactions.

Kiln gases, including products of coal combustion, calcine gases, and dust are treated by dust collectors to remove a portion of the dust and other emission control devices to reduce cabon monoxide, nitrogen oxides, and sulfur dioxide. These devices are typically, ammonia-based Selective Non-Catalytic Reduction (SNCR) and Selective Catalytic Reduction (SCR) systems to remove the majority of the nitrogen oxide pollutants, and lime-based Flash Dryer Absorber (FDA) to remove a majority of the sulfur dioxide pollutants. Carbon monoxide can be reduced by air enrichment and thermal oxidation.

Waste heat contained in the kiln gas and hot clinker product is captured by heat exchangers and made available to heat boiler feed water.

The clinker product is ground to a fine size, typically less than 74 microns, and marketed as a cement additive and as a cementitious material to manufacture a wood-based building material called WoodBrik™.

The project has tangible environmental and economic benefits. The pile of waste coal used to fire the CFBC boiler has presented a significant ongoing environmental challenge by generating acid that migrates into groundwater and surface waterways. The pile is being reclaimed as a fuel for the boiler, thus permanently eliminating the damage to the environment. A portion of the ash produced by the boiler is diverted as a feed material to the kiln thus relieving the space required for disposal. The balance of the ash, which contains some alkaline material (free lime) is returned to the coal waste deposit and can be used to mitigate ongoing acid drainage. Overall fuel usage (and carbon dioxide that is emitted during combustion) is reduced by using waste heat produced by the kiln for useful purposes in the steam and turbine cycle associated with electrical power production. The entire integrated facility reduces the ongoing cost of maintaining a substantial waste coal pile, and produces salable electricity, cement additive, and building material.

This Summary of the Invention is not intended to, nor does it, describe all embodiments of the present invention, either generally or in particular. One of skill in the art will understand the scope of the present invention through its description in the drawings, the entire specification, including the Detailed Description of Preferred Embodiments as well as in the claims.

### BRIEF DESCRIPTION OF THE DRAWINGS

FIG. 1 depicts one embodiment of the present invention that demonstrates the production of pozzolanic material in accordance with the present invention.

### DETAILED DESCRIPTION OF THE PREFERRED EMBODIMENT

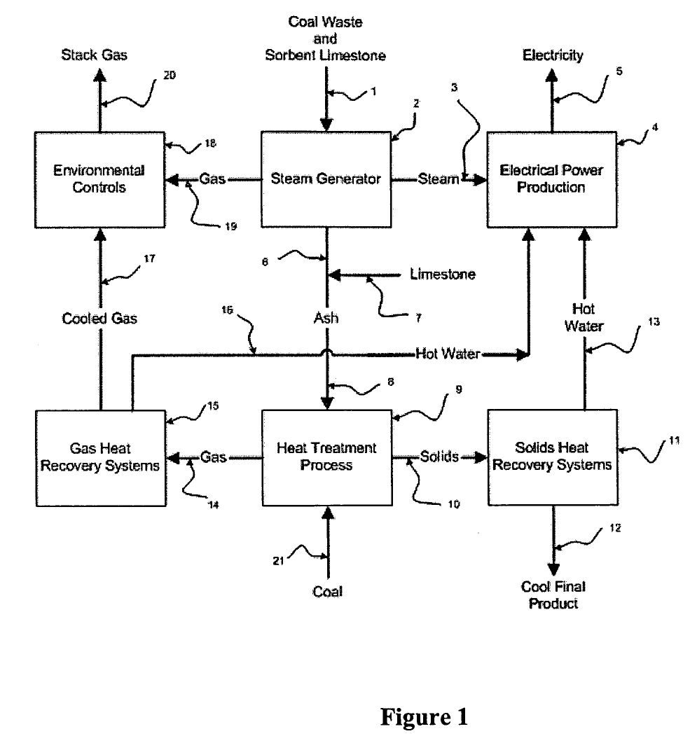

The preferred embodiment of the invention is shown in FIG. 1. Coal waste and sorbent limestone used to control sulfur dioxide emissions (1) is feed to a steam generator (2) and combusted to make steam (3). Useful energy contained in the steam is extracted by turbines and generators contained in the electrical power production section (4) to produce electricity (5).

Ash (6) produced by combusting coal in the steam generator is mixed in a specified proportion with limestone (7) to serve as a feed stock (8) for an elevated-temperature treatment process kiln (9). The kiln produces hot solids (10) having the desired physical and chemical properties. Thermal energy required for treatment is supplied by combusting coal (21).

The solids are cooled in a solids heat recovery system (11) to produce cooled material (12). Boiler feed water, used in electrical power production, is heated in the heat exchanger and returned as hot boiler feed water (13) to the electrical power production unit.

In a similar manner, hot gases (14) produced by the kiln are cooled in a gas heat recovery system (15) to produce hot boiler feed water (16) and cooled gas (17). The gas heat recovery system is operated to produce a cooled gas stream of a specified temperature that is favorable for reactions with ammonia-based nitrogen oxide control systems and lime-based sulfur dioxide control systems (18). Gases (19) emitted by the steam generator can be treated by some of the environmental controls to produce stack gas (20) of sufficiently low pollutants to be vented to the atmosphere.

In another embodiment of the invention, the environmental controls for the kiln may be separate from environmental control equipment used by the steam generator.

While various embodiments of the present invention have been described in detail, it will be apparent that further modifications and adaptations of the invention will occur to those skilled in the art. It is to be expressly understood that such modifications and adaptations are within the spirit and scope of the present invention.

What is claimed is:

1. A method of producing a pozzolanic material comprising:
providing coal combustion by-products and limestone in predetermined proportions; and
exposing said combustion by-products and limestone to an elevated temperature sufficient to form a pozzolanic material having desired physical and chemical properties.

2. The method according to claim 1, wherein said coal combustion by-products include bottom ash and/or fly ash produced by coal-fired boilers.

3. The method as set forth in claim 1, wherein a fluidized bed combustion unit is employed in said exposing step.

4. The method according to claim 1, further comprising adding calcareous materials to said combustion by-products.

5. The method according to claim 1, further comprising pre-mixing said combustion by-products and limestone and treating a resultant mixture with high temperatures to form a material of physical and chemical properties consistent of pozzolanic materials.

6. The method according to claim 5, further comprising exposing said by-products and limestone to a temperature of at least about 900° C.

7. The method according to claim 5, further comprising cooling gases produced by said treating step.

8. The method according to claim 1, further comprising recycling energy recovered in said method to increase a temperature of boiler feed water.

9. The method according to claim 5, further comprising cooling solid products produced by said method in an air-cooled heat exchanger and passing the resulting heated air through a heat exchanger.

10. The method according to claim 9, further comprising increasing the temperature of boiler feed water using energy generated by said method.

11. The method according to claim 1 wherein said material produced by said method is combined with a cement additive in at least a 50/50 ratio of cement to said material.

12. The method according to claim 1, further comprising adding corn stover, wood fibers or fiberous materials to said material.

13. The method according to claim 1 wherein a ratio of coal combustion by-products and limestone is at least one part coal combustion by-product to one part limestone.

14. The method according to claim 1, wherein the temperature employed is between 900° C. and 1,450° C.

15. The method according to claim 1, further comprising treating a gas produced in the method with an ammonia-based selective non-catalytic reduction technique, whereby the concentration of nitrogen oxides is reduced.

16. The method according to claim 1, further comprising treating gases produced by said method with at least one lime-containing compound, whereby said compound is effective to reduce the concentration of sulfur dioxide.

17. The method according to claim 5, further comprising specifying predetermined operating conditions to retain certain sulfur-bearing minerals in a final product.

18. The method according to claim 17, wherein said sulfur-bearing minerals provide a rapid setting characteristic to said final product when said final product is hydrated.

19. The method according to claim 17, further comprising employing a steam generator and supplying a feed material thereto, wherein the calcium-to-sulfur molar ratio in said feed material is at least about 3-to-1.

20. The method according to claim 1, further comprising employing air enrichment and thermal oxidation to reduce carbon monoxide contents of gases produced.
